(19) United States
(12) Patent Application Publication
(10) Pub. No.: US 2012/0316310 A1
(43) Pub. Date: Dec. 13, 2012

(54) ETHYLENE-alpha-OLEFIN COPOLYMER

(75) Inventors: Jumma Nomura, Ichihara-shi (JP); Kazuo Takaoki, Ichihara-shi (JP); Takeshi Hatakeyama, Sodegaura-shi (JP); Yoshinobu Nozue, Ichihara-shi (JP); Yasutoyo Kawashima, Pasadena, CA (US)

(73) Assignee: SUMITOMO CHEMICAL COMPANY, LIMITED, Chuo-ku, Tokyo (JP)

(21) Appl. No.: 13/515,168

(22) PCT Filed: Dec. 3, 2010
(86) PCT No.: PCT/JP2010/072188

§ 371 Date: Aug. 27, 2012

(30) Foreign Application Priority Data
Dec. 15, 2009 (JP) 2009-283778

(51) Int. Cl. C08F 210/02

(52) U.S. Cl. 526/348

(57) ABSTRACT

The present invention relates to an ethylene-α-olefin copolymer comprising monomer units derived from ethylene and monomer units derived from an α-olefin having from 3 to 20 carbon atoms, wherein the copolymer has a melt flow rate of 0.01 to 100 g/10 min, a density of 860 to 970 kg/m³, a molecular weight distribution of 5.5 to 12, and an activation energy of flow of 50 to 100 kJ/mol, and when the maximum take-up rate of the copolymer at 150° C. is represented by MTV₁₅₀ and the maximum take-up rate of the copolymer at 190° C. is represented by MTV₁₉₀, MTV₁₅₀ is 40 m/min or more, and the ratio of MTV₁₅₀ to MTV₁₉₀ is 1 or less.

### TECHNICAL FIELD

The present invention relates to an ethylene-α-olefin copolymer, a resin composition containing the copolymer, and a film formed of the resin composition.

### BACKGROUND ART

Ethylene-based polymers have been shaped into film, sheet, bottle, etc. by various forming processes, such as blown film process, flat die process, blow molding, and injection molding, and have been used for various applications. Such ethylene-based polymers have been requested to be superior in processability, such as to exhibit a low motor load in melt-extrusion by an extruder, to afford a stable bubble in blown process, and to prevent a parison from sagging in blow molding. For example, there have been proposed a polymer produced by polymerizing ethylene using a polymerization catalyst composed of silica carrying methylalumoxane thereon, a specific metallocene complex, and triisobutylaluminum and a polymer produced by polymerizing ethylene using a polymerization catalyst composed of silica carrying a specific metallocene complex and methylalumoxane thereon and triisobutylaluminum (see, for example, JP 4-213309 A). Moreover, there have been proposed, for example, a polymer produced by copolymerizing ethylene with an α-olefin using a catalyst composed of triisobutylaluminum, racemic ethylenebis(1-indenyl)zirconium diphenoxide, and a co-catalyst carrier prepared by bringing pentafluorophenol into contact with diethylzinc, then bringing silica treated with hexamethyldisilazane into contact therewith, and then bringing water into contact therewith (see, for example, JP 2003-171412 A), a polymer produced by copolymerizing ethylene with an α-olefin using a catalyst composed of triisobutylaluminum, racemic ethylenebis (1-indenyl) zirconium diphenoxide, and a co-catalyst carrier prepared by bringing diethylzinc into contact with silica treated with hexamethyldisilazane, then bringing pentafluorophenol into contact therewith, and then bringing water into contact therewith (see, for example, JP 2004-149760 A and JP 2005-97481 A).

However, the above-described ethylene-based polymers have not been satisfactory with respect to a balance among mechanical strength, extrusion load and take-up property in a high temperature region in processing.

### DISCLOSURE OF THE INVENTION

Under such circumstances, the problem which the present invention tends to solve is to provide an ethylene-based polymer which is superior in balance between mechanical strength and extrusion load in processing and also superior in take-up property in a high temperature region.

That is, the present invention relates to an ethylene-α-olefin copolymer comprising monomer units derived from ethylene and monomer units derived from an α-olefin having from 3 to 20 carbon atoms, wherein the copolymer has a melt flow rate of 0.01 to 100 g/10 min, a density of 860 to 970 kg/m³, a molecular weight distribution of 5.5 to 12, and an activation energy of flow of 50 to 100 kJ/mol, and when the maximum take-up rate of the copolymer at 150° C. is represented by MTV₁₅₀ and the maximum take-up rate of the copolymer at 190° C. is represented by MTV₁₉₀, MTV₁₅₀ is 40 m/min or more, and the ratio of MTV₁₅₀ to MTV₁₉₀ is 1 or less.

### MODE FOR CARRYING OUT THE INVENTION

The ethylene-α-olefin copolymer of the present invention is a copolymer that has monomer units derived from ethylene and monomer units derived from an α-olefin having from 3 to 20 carbon atoms. Examples of the α-olefin having from 3 to 20 carbon atoms include propylene, 1-butene, 4-methyl-1-pentene, 1-hexene, 1-octene, and 1-decene. More preferred are 1-butene and 1-hexene. The above-mentioned α-olefin having from 3 to 20 carbon atoms may be used singly or alternatively two or more members thereof may be used in combination.

The content of the monomer units derived from ethylene in the ethylene-α-olefin copolymer of the present invention is usually 50% by weight or more where the overall weight of the ethylene-α-olefin copolymer is 100% by weight. The content of the monomer units derived from α-olefin having from 3 to 20 carbon atoms is usually 50% by weight or less where the overall weight of the ethylene-α-olefin copolymer is 100% by weight.

The ethylene-α-olefin copolymer of the present invention may have monomer units derived from a monomer other than ethylene and α-olefins having from 3 to 20 carbon atoms in addition to the monomer units derived from ethylene and the monomer units derived from an α-olefin having from 3 to 20 carbon atoms as far as the effect of the present invention is not impaired; examples of such a monomer include conjugated dienes, such as 1,3-butadiene and 2-methyl-1,3-butadiene; nonconjugated dienes, such as 1,4-pentadiene and 1,5-hexadiene; unsaturated carboxylic acids, such as acrylic acid and methacrylic acid; unsaturated carboxylic acid esters, such as methyl acrylate, ethyl acrylate, butyl acrylate, methyl methacrylate, and ethyl methacrylate; and vinyl ester compounds, such as vinyl acetate.

Examples of the ethylene-α-olefin copolymer of the present invention include ethylene-propylene copolymers, ethylene-1-butene copolymers, ethylene-1-hexene copolymers, ethylene-4-methyl-1-pentene copolymers, ethylene-1-octene copolymers, ethylene-1-butene-1-hexene copolymers, ethylene-1-butane-4-methyl-1-pentene copolymers, and ethylene-1-butene 1-octene copolymers. Preferred are ethylene-1-butene copolymers, ethylene-1-hexene copolymers, ethylene-1-octene copolymers, ethylene-1-butene-1-hexene copolymers, and ethylene-1-butene-1-octene copolymers; ethylene-1-hexene copolymers are more preferred.

The melt flow rate (MFR) of the ethylene-α-olefin copolymer of the present invention is from 0.01 to 100 g/10 min. In order to obtain a molded article with good mechanical strength, the MFR of the ethylene-α-olefin copolymer is preferably 10 g/10 min or less, more preferably 5 g/10 min or less, even more preferably 3 g/10 min or less, still more preferably 2 g/10 min or less, and most preferably 1 g/10 min or less. From the viewpoint of processability, it is preferably 0.05 g/10 min or more, and more preferably 0.1 g/10 min or more. The MFR is measured under conditions represented by a temperature of 190° C. and a load of 21.18 N by method A provided in accordance with JIS K7210-1995.

The density of the ethylene-α-olefin copolymer of the present invention is from 860 to 970 kg/m³. In order to obtain a molded article with good mechanical strength, the density is preferably 940 kg/m³ or less, more preferably 930 kg/m³ or less, and even more preferably 925 kg/m³ or less. In order to obtain a molded article with good stiffness, the density is preferably 910 kg/m³ or more, and more preferably 915 kg/m³ or more. The density is measured in accordance with method A provided in JIS K7112-1980 using a sample subjected to the annealing disclosed in JIS K6760-1995.

The molecular weight distribution (Mw/Mn) of the ethylene-α-olefin copolymer of the present invention is from 5.5 to 12. In order to obtain a molded article with good mechanical strength, the molecular weight distribution of the ethylene-α-olefin copolymer is preferably 11 or less, and more preferably 8 or less. From the viewpoint of processability, it is preferably 6 or more. The molecular weight distribution (Mw/Mn) is a value (Mw/Mn) obtained by measuring a polystyrene-equivalent weight average molecular weight (Mw) and a polystyrene-equivalent number average molecular weight (Mn) by gel permeation chromatography measurement and then dividing the Mw by the Mn.

From the viewpoint of flowability, the activation energy of flow (Ea, the unit thereof is kJ/mol) of the ethylene-α-olefin copolymer of the present invention is preferably 50 kJ/mol or more, more preferably 55 kJ/mol or more, and even more preferably 60 kJ/mol or more. In order to make an ethylene-α-olefin copolymer easy to mold at high temperatures, the Ea is preferably 100 kJ/mol or less, and more preferably 90 kJ/mol or less.

The ratio (Mz/Mw) of the polystyrene-equivalent z average molecular weight (Mz) to the polystyrene-equivalent weight average molecular weight (Mw) of the ethylene-α-olefin copolymer of the present invention is preferably from 2.0 to 3.0. In order to obtain a molded article with good mechanical strength, the Mz/Mw of the ethylene-α-olefin copolymer is preferably 2.6 or less, more preferably 2.5 or less, and even more preferably 2.4 or less. From the viewpoint of processability, the Mz/Mw is preferably 2.1 or more, more preferably 2.2 or more, and even more preferably 2.3 or more.

From the viewpoint of processability, the maximum take-up rate (MTV₁₅₀) at a temperature of 150° C. of the ethylene-α-olefin copolymer of the present invention is 40 m/min or more, more preferably 45 m/min or more, even more preferably 50 m/min or more, and further more preferably 55 m/min or more.

When the maximum take-up rate at a temperature of 190° C. of the ethylene-α-olefin copolymer of the present invention is represented by MTV₁₉₀, the ratio of MTV₁₅₀ to MTV₁₉₀ of the ethylene-α-olefin copolymer of the present invention, i.e., MTV₁₅₀/MTV₁₉₀, is less than 1.

Such an ethylene-α-olefin copolymer of the present invention is superior in take-up property in a high temperature region.

The η*_{0.1}/η*₁₀₀ of the ethylene-α-Olefin copolymer of the present invention is preferably from 5 to 100. From the viewpoint of improving processability, the η*_{0.1}/η*₁₀₀ is preferably 6 or more, and more preferably 8 or more. In order to obtain a molded article with good mechanical strength, the η*_{0.1}/η*₁₀₀ is preferably 80 or less, more preferably 70 or less, and even more preferably 60 or less. The η₁₀₀ is the dynamic complex viscosity (unit: Pa·sec) of an ethylene-α-olefin copolymer at a temperature of 190° C. and an angular frequency of 100 rad/sec; the η*_{0.1} is the dynamic complex viscosity (unit: Pa·sec) of an ethylene-α-olefin copolymer at a temperature of 190° C. and an angular frequency of 0.1 rad/sec. The η*_{0.1} and the η*₁₀₀ are measured by using a viscoelasticity analyzer (e.g., Rheometrics Mechanical Spectrometer RMS-800 manufactured by Rheometrics, Inc.).

The η*₁₀₀ of the ethylene-α-olefin copolymer of the present invention is preferably 1200 Pa·sec or less. From the viewpoint of improving processability, the η*₁₀₀ is preferably 1100 Pa·sec or less, more preferably 1000 Pa·sec or less, and even more preferably 900 Pa·sec or less. In order to obtain a molded article with good mechanical strength, the W100 is preferably 600 Pa·sec or more, more preferably 750 Pa·sec or more, even more preferably 800 Pa·sec or more, and most preferably 850 Pa·sec or more.

The melt flow rate ratio (MFRR) of the ethylene-α-olefin copolymer of the present invention is preferably from 20 to 150. From the viewpoint of improving processability, it is preferably 30 or more, more preferably 40 or more, even more preferably 50 or more, and further more preferably 60 or more. From the viewpoint of the strength of a molded article, the MFRR is preferably 140 or less and more preferably 130 or less. The melt flow rate ratio (MFRR) is a value obtained by dividing a melt flow ratio value measured at 190° C., a load of 211.82 N (21.60 kg) in accordance with a method provided in JIS K7210-1995 by a melt flow rate value measured at 190° C., a load of 21.18 N (2.16 kg).

The ΔT_{1/2} of the ethylene-α-olefin copolymer of the present invention is preferably from 1 to 5° C. When producing a shrink film using the ethylene-α-olefin copolymer, in order to make the film easy to shrink, the ΔT_{1/2} is preferably 4° C. or lower, more preferably 3° C. or lower, and even more preferably 2.5° C. or lower. From the viewpoint of heat resistant, the ΔT_{1/2} is preferably 1.2° C. or higher.

The ΔT_{1/2} of an ethylene-α-olefin copolymer can be determined by the following method. First, the melting point Tm (unit: ° C.) and the fusion enthalpy ΔH (unit: J/g) of the ethylene-α-olefin copolymer are measured by using a differential scanning calorimeter Diamond DSC manufactured by PerkinElmer Inc. The melting point as referred to herein is a melting peak temperature measured by holding 6 to 12 mg of a sample filled in an aluminum pan at 150° C. for 5 minutes, then cooling it at a rate of 5° C./min to 20° C., holding it at 20° C. for 2 minutes, and then heating it at a rate of 5° C./rain to 150° C. When there are two or more peaks, the temperature of the position of the melting peak which exhibits the highest amount of heat absorbance (unit: mW) among them is defined as the highest melting point Tₘₐₓ (unit: ° C.). When the value of the middle amount of heat absorbance between the amount of heat absorbance at Tₘₐₓ and the baseline amount of heat absorbance of the melting curve is represented by Q, the difference between Tₘₐₓ and the highest temperature among temperatures at which the amount of heat absorbance on the endothermic curve is Q is defined as a half-value width at the higher temperature side, ΔT_{1/2}.

The integral value of the amount of heat of fusion observed at the higher temperature side than Tₘₐₓ is represented by ΔH_{high} (unit: J/g). The ratio (ΔH_{high}/ΔH) of the ΔH_{high} to the amount of heat of fusion observed in the entire measured range ΔH of the ethylene-α-olefin copolymer of the present invention is preferably from 0.05 to 0.50.

From the viewpoint of heat resistance, the ΔH_{high}/ΔH is more preferably 0.10 or more. When producing a shrink film using the ethylene-α-olefin copolymer, in order to make the film easy to shrink, the ΔH_{high}/ΔH is more preferably 0.40 or less, even more preferably 0.30 or less, further more preferably 0.25 or less, and most preferably 0.20 or less. The number of the melting peak temperature observed is preferably one.

Examples of a method for producing the ethylene-α-olefin copolymer of the present invention include a method in which ethylene and an α-olefin are copolymerized together in the presence of a polymerization catalyst prepared by using, as catalyst components, a co-catalyst carrier in the form of solid particles (henceforth, component (A)) obtained by bringing diethylzinc (henceforth, component (a)), 1,1-bis(trifluoromethyl)-2,2,2-trifluoroethanol (henceforth, component (b)), water (henceforth, component (c)) and an inorganic compound particle (henceforth, component (d)) into contact with each other in a toluene solvent, a metallocene complex having a structure which has two ligands each having a cyclopentadienyl skeleton and in which the two ligands are combined by a cross-linking group, such as an alkylene group and a silylene group (henceforth, component (B)), and an organoaluminum compound (henceforth, component (C)).

Component (d) may optionally be subjected to contact treatment with 1,1,1,3,3,3-hexamethyldisilazane H(CH₃)₃Si)₂NH) (henceforth, component (e)).

By using component (A) as a co-catalyst carrier in the form of solid particles the ethylene-α-olefin copolymer of the present invention in which the ratio (MTV₁₅₀/MTV₁₉₀) of the maximum take-up rate (MTV₁₅₀) at a temperature of 150° C. to the maximum take-up rate (MTV₁₉₀) at a temperature of 190° C. is 1 or less can be produced.

The inorganic compound particle of component (d) is preferably silica gel.

Although the use amounts of component (a), component (b), and component (c) are not particular limited, it is preferred that y and z substantially satisfy the following formula (I) where the molar ratio of the use amounts of these components is a molar ratio of component (a):component (b):component (c)=1:y:z.

0.5<y+2z<5 (1)

y in the above formula (1) is preferably a number of from 0.5 to 4, more preferably a number of from 0.6 to 3, even more preferably a number of from 0.8 to 2.5, and most preferably a number of from 1 to 2. z in the above formula (1) is a positive number larger than 0 and can arbitrarily take the range determined by y and the above formula (1).

The contact order of component (a), component (b), component (c), and component (d) includes the following orders.

<1> Component (d) and component (a) are brought into contact with each other, followed by component (b), and then followed by component (c).
<2> Component (d) and component (b) are brought into contact with each other, followed by component (a), and then followed by component (c).

The contact order of component (a), component (b), component (c), component (d), and component (e) includes the following orders.

<3> Component (d) and component (e) are brought into contact with each other, followed by component (a), followed by component (b), and then followed by component (c).
<4> Component (d) and component (e) are brought into contact with each other, followed by component (b), followed by component (a), and then followed by component (c).

A preferable contact order is <1>.

The contact treatment of component (a), component (b), component (c), component (d), and component (e) is preferably conducted under an inert gas atmosphere. The treatment temperature is usually from −100 to 300° C., preferably from −80 to 200° C. The treatment time is usually from one minute to 200 hours, preferably from 10 minutes to 100 hours.

As the metal atom in the metallocene complex of component (B), atoms of Group IV of the Periodic Table are preferred, and zirconium and hafnium are more preferred. As the ligand having a cyclopentadienyl skeleton, an indenyl group, a methylindenyl group, a methylcyclopentadienyl group, and a dimethylcyclopentadienyl group are preferred; an ethylene group and a dimethylmethylene group are preferred as the cross-linking group. Moreover, a diphenoxy group and a dialkoxy group are preferred as the remaining substituent(s) which the metal atom has. As the metallocene complex, ethylenebis(1-indenyl) zirconium diphenoxide is preferred.

Triisobutylaluminum, trinormaloctylaluminum, triethylaluminum, and trimethylaluminum are preferred as the organoaluminum compound of the above component (C).

The use amount of the metallocene complex of component (B) is preferably from 5×10⁻⁶ to 5×10⁻⁴ mol per gram of the co-catalyst carrier of component (A). The use amount of the organoaluminum compound of component (C), which is represented by the ratio (Al/M) of the number of moles of the aluminum atom of the organoaluminum compound of component (C) to the number of moles of the metal atom of the metallocene complex of component (B), is preferably from 1 to 5000.

The above-described polymerization catalyst prepared by bringing the co-catalyst carrier (A), metallocene complex (B), and organoaluminum compound (C) into contact with each other may optionally be a polymerization catalyst prepared by bringing an electron donating compound (D) into contact with the co-catalyst carrier (A), metallocene complex (B) and organoaluminum compound (C). Preferably, examples of the electron donating compound (D) include triethylamine and trinormaloctylamine.

From the viewpoint of making the molecular weight distribution of an ethylene-α-olefin copolymer to be obtained high, it is preferred to use an electron donating compound (D) and the use amount of the electron donating compound (D) is preferably 0.1 mol % or more, more preferably 1 mol % or more, based on the number of moles of the aluminum atom of the organoaluminum compound (C). From the viewpoint of increasing polymerization activity, the use amount is preferably 30 mol % or less, more preferably 20 mol % or less, and even more preferably 10 mol % or less.

The polymerization method is preferably a continuous polymerization method accompanied by formation of ethylene-α-olefin copolymer particles, e.g., continuous gas phase polymerization, continuous slurry polymerization and continuous bulk polymerization; continuous gas phase polymerization is preferred. The gas phase polymerization apparatus to be used for the polymerization method is usually an apparatus having a fluid bed type reaction vessel, preferably an apparatus having a fluid bed type reaction vessel with an enlarged part. A stirring blade may be mounted in the reaction vessel.

Examples of methods for feeding the components of the polymerization catalyst to be used in the production of the ethylene-α-olefin copolymer of the present invention to a reaction vessel include a method in which the components are fed using an inert gas such as nitrogen and argon, hydrogen, ethylene or the like under water-free conditions, and a method in which the components are dissolved or diluted in a solvent and fed in the form of solution or slurry. The components of the catalyst may be fed separately or alternatively may be fed after being brought into contact with each other in arbitrary order beforehand.

It is permitted that prepolymerization be conducted before performing main polymerization and the prepolymerized catalyst components be used as the catalyst components or catalyst for the main polymerization.

The polymerization temperature is usually lower than a temperature at which the ethylene-α-olefin copolymer is melted, preferably from 0 to 150° C., more preferably from 30 to 100° C., even more preferably from 60 to 100° C., and particularly preferably from 70 to 100° C. By setting the polymerization temperature high, it is possible to reduce the amount of molecules having many long chain branches contained in high molecular weight components contained in the ethylene-α-olefin copolymer or narrow the molecular weight distribution of the ethylene-α-olefin copolymer.

It is also permitted to add hydrogen to a polymerization reactor as a molecular weight regulator for the purpose of adjusting the melt flowability of the ethylene-α-olefin copolymer. Inert gas may also be added to the polymerization reactor. From the viewpoint of making the η*_{0.1}/η*₁₀₀ of the ethylene-α-olefin copolymer large, it is preferred to set the hydrogen concentration in the polymerization reactor low; whereas from the viewpoint of making the η*_{0.1}/η*₁₀₀ small, it is preferred to set the hydrogen concentration high.

Multistage polymerization may be performed in order to extend the molecular weight distribution of the ethylene-α-olefin copolymer.

Hydrogen may be added to the polymerization reactor for the purpose of adjusting the maximum take-up rate of the ethylene-α-olefin copolymer. From the viewpoint of making the maximum take-up rate (MTV₁₅₀) of the ethylene-α-olefin copolymer high, it is preferred to set the hydrogen concentration in the polymerization reactor high; whereas from the viewpoint of making the maximum take-up rate (MTV₁₅₀) low, it is preferred to set the hydrogen concentration low.

The ethylene-α-olefin copolymer of the present invention may optionally contain an additive. Examples of such an additive include antioxidants, weathering agents, lubricants, antiblocking agents, antistatic agents, anticlouding agents, antidripping agent, pigments, and fillers.

Hereinafter, the ethylene-α-olefin copolymer of the present invention is sometimes called ethylene-α-olefin copolymer (A).

The ethylene-α-olefin copolymer (A) of the present invention can be used together with other resin. Examples of such other resin include olefin-based resins, such as ethylene-based resins differing from the ethylene-α-olefin copolymer (A) of the present invention and propylene-based resins.

As to the contents of the ethylene-α-olefin copolymer (A) and an ethylene-based copolymer (B) in the resin composition containing the ethylene-α-olefin copolymer (A) and the ethylene-based copolymer (B), from the viewpoint of improving optical properties, the content of the ethylene-α-olefin copolymer (A) is 5% by weight or more and the content of the ethylene-based copolymer (B) is 95% by weight or less, and preferably the content of the ethylene-α-olefin copolymer (A) is 10% by weight or more and the content of the ethylene-based copolymer (B) is 90% by weight or less, where the sum total of the ethylene-α-olefin copolymer (A) and the ethylene-based copolymer (B) is 100% by weight. From the viewpoint of improving optical properties, the content of the ethylene-α-olefin copolymer (A) is 95% by weight or less and the content of the ethylene-based copolymer (B) is 5% by weight or more, preferably the content of the ethylene-α-olefin copolymer (A) is 70% by weight or less and the content of the ethylene-based copolymer (B) is 30% by weight or more, and more preferably the content of the ethylene-α-olefin copolymer (A) is 50% by weight or less and the content of the ethylene-based copolymer (B) is 50% by weight or more.

The ethylene-α-olefin copolymer of the present invention can be superior in mechanical strength and balance between extrusion load in processing and take-up property in a high temperature region. The ethylene-α-olefin copolymer of the present invention and materials comprising this copolymer are formed by known forming processes, such as extrusion forming processes including a blown film process and flat die process, an injection molding, and a compression molding into various types of molded articles (film, sheet, bottle, tray, etc.). A blown film process is used preferably as a forming process, and formed articles to be obtained are used for various applications, such as food packaging and surface protection.

### EXAMPLES

The present invention is explained by reference to Examples and Comparative Examples below.

The measured values of the respective items in the Examples and Comparative Examples were measured in accordance with the following methods.

Samples were each prepared by beforehand optionally blending 1000 ppm or more of an antioxidant, such as IRGANOX 1076.

(1) Melt Flow Rate (MFR; Unit: g/10 min)

Measurement was conducted by method A under conditions represented by a load of 21.18 N and a temperature of 190° C. in accordance with the method provided in JIS K7210-1995.

### (2) Density (Unit: Kg/m³)

Measurement was conducted in accordance with the method provided in method A in JIS K7112-1980. Samples were subjected to the annealing disclosed in JIS K6760-1995.

### (3) Mw/Mn, Mz/Mw

A polystyrene-equivalent weight average molecular weight (Mw) and a polystyrene-equivalent number average molecular weight (Mn) were determined by gel permeation chromatography (GPC) measurement and a value obtained by dividing Mw by Mn was defined as molecular weight distribution (Mw/Mn). A polystyrene-equivalent Z-average molecular weight (Mz) and a polystyrene-equivalent weight average molecular weight (Mw) were determined by gel permeation chromatography (GPC) measurement and the ratio of Mz to Mw was defined as Mz/Mw.

Instrument: Waters 150 C manufactured by Waters

Separation column: TOSOH TSKgel GMH-HT

Measurement temperature: 140° C.

Carrier: orthodichlorobenzene

Flow rate: 1.0 mL/min

Injection amount: 500 μL.

(4) η*_{0.1}/η*₁₀₀

Dynamic complex viscosities from an angular frequency of 0.1 rad/sec to 100 rad/sec were measured under the following conditions by using a strain controlling type rotational viscometer (rheometer), and then a value (η*_{0.1}/η*₁₀₀) resulting from division of the dynamic complex viscosity (η*_{0.1}) at an angular frequency of 0.1 rad/sec by the dynamic complex viscosity (η*₁₀₀) at an angular frequency of 100 rad/sec was calculated. ARES manufactured by TA Instruments was used as the strain controlling type rotational rheometer.

Temperature: 190° C.

Geometry: parallel plates

Plate diameter: 25 mm

Plate distance: 1.5 to 2 mm

Strain: 5%

Angular frequency: 0.1 to 100 rad/sec

Measurement atmosphere: nitrogen

(5) Activation Energy of Flow (Ea, Unit: kJ/mol)

Activation energy of flow Ea was calculated from an Arrhenius' equation: log(aT)=Ea/R(1/T−1/T0) (R is the gas constant and To is a standard temperature 463K) of a shift factor (aT) in shifting, on the basis of the principal of temperature-time superposition, dynamic viscoelasticity data at each temperature T (K) measured under the following conditions (a) through (d) by using a strain controlling type rotational viscometer (rheometer). Rhios V.4.4.4 produced by Reometrics was used as the calculation software and there was adopted an Ea value obtained when the correlation factor r2 was 0.99 or more in approximating to straight a line in Arrhenius' type plot log(aT)−(1/T). Measurement was carried out under nitrogen.

Condition (a) Geometry: parallel plate; diameter: 25 mm, plate distance: 1.5 to 2 m

Condition (b) Strain: 5%

Condition (c) Shear rate: 0.1 to 100 rad/sec

Condition (d) Temperature: 190, 170, 150, 130° C.

(6) Tensile Impact Strength (Unit: kJ/m²)

The tensile impact strength of a 2 mm thick sheet prepared by compression molding under the conditions including a molding temperature of 190° C., a preheating time of 10 minutes, a compression time of 5 minutes and a compression pressure of 5 MPa was measured in accordance with ASTM D1822-68. The larger this value, the better the mechanical strength.

(7) Maximum Take-Up Rate (MTV; Unit: m/min)

Using a melt tension tester manufactured by Toyo Seiki Seisaku-Sho, Ltd., molten resin filled in a 9.5 mmφ barrel was extruded through an orifice of 2.09 mm in diameter and 8 mm in length at a piston falling rate of 5.5 mm/min (shear rate of 7.4 sec⁻¹) at temperatures of 150° C. and 190° C. The extruded molten resin was taken up at a take-up rate of 40 rpm/min by using a take-up roll of 50 mm in diameter and a take-up rate (MTV; unit: m/min) just before breakage of the molten resin was measured. The larger this value, the better the high-speed processability.

### (8) Melt Flow Rate Ratio (MFRR)

A value obtained by dividing a melt flow rate value measured by method A under a load of 211.82 N at a temperature of 190° C. by a value measured by method A under a load of 21.18 N at a temperature of 190° C. in accordance with the method provided in JIS K7210-1995 was defined as an MFRR. The larger this value, the lower the extrusion torque in forming and, accordingly, the better the processability.

### Example 1

### (1) Preparation of Co-Catalyst Carrier

A 200-ml separable flask with a tank diameter of 58 mm equipped with two finger-type baffle plates and a Pfaudler type impeller having a diameter of 35 mm was purged with nitrogen gas. 60 ml of toluene as a solvent and 10.6 g of silica (Sylopol 948 produced by Davison Co., Ltd.; average particle diameter: 55 μm; pore volume: 1.67 ml/g; specific surface area: 325 m²/g) that had been heated at 300° C. under a nitrogen gas flow were charged to the flask, and then stirred. Subsequently, 21.1 ml of a hexane solution of diethylzinc with a diethylzinc concentration of 2 mmol/ml was charged to the flask and stirred. Thereafter, the flask was cooled down to 5° C. and then 19.3 ml of a toluene solution of 1,1-bis (trifluoromethyl)-2,2,2-trifluoroethanol with a 1,1-bis (trifluoromethyl)-2,2,2-trifluoroethanol concentration of 2.22 mmol/ml was dropped over 30 minutes with the temperature within the flask kept at 5° C. After completion of the dropping, stirring was continued at 5° C. for one hour and at 40° C. for one hour. Then, 0.38 ml of water was dropped over 60 minutes with the temperature within the flask kept at 22° C. After completion of the dropping, stirring was continued at 22° C. for 1.5 hours and at 40° C. for one hour. After stopping stirring, the flask was left at rest and then the supernatant liquid within the flask was extracted by using a glass filter, so that a solid component was obtained. The resulting solid component was washed with 70 ml of toluene twice at 40° C. and with 70 ml of hexane once at room temperature. The resulting solid component was dried under reduced pressure at 23° C. for one hour, so that 16.5 g of a co-catalyst carrier (A1) for addition polymerization was obtained.

### (2) Polymerization

A 5-liter autoclave equipped with a stirrer dried under reduced pressure and then purged with argon gas was evacuated. Then, hydrogen was fed thereto so that its partial pressure might become 0.029 MPa, and subsequently 250 mL of 1-hexene and 1031 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.57 mol %. To the system was fed 4.0 mL of a heptane solution of triisobutylaluminum with a triisobutylaluminum concentration of 0.5 mmol/mL. Subsequently, 0.75 mL of a toluene solution of racemic ethylenebis(1-indenyl)zirconium diphenoxide with a racemic ethylenebis(1-indenyl)zirconium diphenoxide concentration of 2 μmol/mL was fed into the autoclave, and then 8.9 mg of the co-catalyst carrier (A1) obtained in the above-described Example 1(1) was fed. Polymerization was carried out at 70° C. for 180 minutes while ethylene/hydrogen mixed gas (hydrogen concentration: 0.35 mol %) was fed continuously so that the overall pressure and the hydrogen concentration in the gas might be maintained constant during the polymerization. The hydrogen concentration within the system after the polymerization for 180 minutes was 1.33 mol % (the hydrogen concentration within the autoclave during the polymerization was 1.45 mol % on average). Then, butane, ethylene, and hydrogen were purged, so that 158.1 g of an ethylene-1-hexene copolymer was obtained. The physical properties of the resulting ethylene-1-hexene copolymer were shown in Table 1.

### Example 2

A 5-liter autoclave equipped with a stirrer dried under reduced pressure and then purged with argon gas was evacuated. Then, hydrogen was fed thereto so that its partial pressure might become 0.033 MPa, and subsequently 270 mL of 1-hexene and 1020 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.86 mol %. To the system was fed 2.0 mL of a heptane solution of triisobutylaluminum with a triisobutylaluminum concentration of 1.0 mmol/mL. Subsequently, 1.0 mL of a toluene solution of racemic ethylenebis (1-indenyl) zirconium diphenoxide with a racemic ethylenebis(1-indenyl)zirconium diphenoxide concentration of 2 μmol/mL was fed, and then 6.4 mg of the co-catalyst carrier (A1) obtained in the above-described Example 1(1) was fed. Polymerization was carried out at 70° C. for 180 minutes while ethylene/hydrogen mixed gas (hydrogen concentration: 0.29 mol %) was fed continuously so that the overall pressure and the hydrogen concentration in the gas might be maintained constant during the polymerization. The hydrogen concentration within the system after the polymerization for 180 minutes was 1.79 mol % (the hydrogen concentration within the system was 1.82 mol % on average). Then, butane, ethylene, and hydrogen were purged, so that 176.6 g of an ethylene-1-hexene copolymer was obtained. The physical properties of the resulting ethylene-1-hexene copolymer were shown in Table 1.

### Example 3

A 5-liter autoclave equipped with a stirrer dried under reduced pressure and then purged with argon gas was evacuated. Then, hydrogen was fed thereto so that its partial pressure might become 0.021 MPa, and subsequently 280 mL of 1-hexene and 1012 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.08 mol %. To the system was fed 4.0 mL of a heptane solution of triisobutylaluminum with a triisobutylaluminum concentration of 0.5 mmol/mL. Subsequently, 1.0 mL of a toluene solution of racemic ethylenebis (1-indenyl) zirconium dichloride with a racemic ethylenebis(1-indenyl)zirconium dichloride concentration of 1 μmol/mL was fed, and then 4.1 mg of the co-catalyst carrier (A1) obtained in the above-described Example 1(1) was fed. Polymerization was carried out at 70° C. for 180 minutes while ethylene/hydrogen mixed gas (hydrogen concentration: 0.24 mol %) was fed continuously so that the overall pressure and the hydrogen concentration in the gas might be maintained constant during the polymerization. The hydrogen concentration within the system after the polymerization for 180 minutes was 1.21 mol % (the hydrogen concentration within the system was 1.15 mol % on average). Then, butane, ethylene, and hydrogen were purged, so that 121.3 g of an ethylene-1-hexene copolymer was obtained. The physical properties of the resulting ethylene-1-hexene copolymer were shown in Table 1.

### Example 4

A 5-liter autoclave equipped with a stirrer dried under reduced pressure and then purged with argon gas was evacuated. Then, hydrogen was fed thereto so that its partial pressure might become 0.030 MPa, and subsequently 280 mL of 1-hexene and 1020 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.41 mol %. To the system was fed 2.0 mL of a heptane solution of triisobutylaluminum with a triisobutylaluminum concentration of 1.0 mmol/mL. Subsequently, 1.0 mL of a toluene solution of racemic ethylenebis (1-indenyl) zirconium diphenoxide with a racemic ethylenebis(1-indenyl)zirconium diphenoxide concentration of 2 μmol/mL was fed, and then 6.0 mg of the co-catalyst carrier (A1) obtained in the above-described Example 1(1) was fed. Polymerization was carried out at 70° C. for 180 minutes while ethylene/hydrogen mixed gas (hydrogen concentration: 0.37 mol %) was fed continuously so that the overall pressure and the hydrogen concentration in the gas might be maintained constant during the polymerization. The hydrogen concentration within the system after the polymerization for 180 minutes was 1.72 mol % (the hydrogen concentration within the system was 1.57 mol % on average). Then, butane, ethylene, and hydrogen were purged, so that 168.4 g of an ethylene-1-hexene copolymer was obtained. The physical properties of the resulting ethylene-1-hexene copolymer were shown in Table 1.

### Example 5

A 5-liter autoclave equipped with a stirrer dried under reduced pressure and then purged with argon gas was evacuated. Then, hydrogen was fed thereto so that its partial pressure might become 0.029 MPa, and subsequently 250 mL of 1-hexene and 1031 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.41 mol %. To the system was fed 2.0 mL of a heptane solution of triisobutylaluminum with a triisobutylaluminum concentration of 1.0 mmol/mL. Subsequently, 1.0 mL of a toluene solution of racemic ethylenebis (1-indenyl) zirconium diphenoxide with a racemic ethylenebis (1-indenyl) zirconium diphenoxide concentration of 2 μmol/mL was fed, and then 8.9 mg of the co-catalyst carrier (A1) obtained in the above-described Example 1(1) was fed. Polymerization was carried out at 70° C. for 180 minutes while ethylene/hydrogen mixed gas (hydrogen concentration: 0.35 mol %) was fed continuously so that the overall pressure and the hydrogen concentration in the gas might be maintained constant during the polymerization. The hydrogen concentration within the system after the polymerization for 180 minutes was 1.31 mol % (the hydrogen concentration within the system was 1.36 mol % on average). Then, butane, ethylene, and hydrogen were purged, so that 108.2 g of an ethylene-1-hexene copolymer was obtained. The physical properties of the resulting ethylene-1-hexene copolymer were shown in Table 1.

### Example 6

A 5-liter autoclave equipped with a stirrer dried under reduced pressure and then purged with argon gas was evacuated. Then, hydrogen was fed thereto so that its partial pressure might become 0.027 MPa, and subsequently 250 mL of 1-hexene and 1033 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.42 mol %. To the system was fed 2.0 mL of a heptane solution of triisobutylaluminum with a triisobutylaluminum concentration of 1.0 mmol/mL. Subsequently, 1.5 mL of a toluene solution of racemic ethylenebis(1-indenyl)zirconium diphenoxide with a racemic ethylenebis(1-indenyl)zirconium diphenoxide concentration of 1.0 μmol/mL was fed, and then 8.7 mg of the co-catalyst carrier (A1) obtained in the above-described Example 1(1) was fed. Polymerization was carried out at 70° C. for 180 minutes while ethylene/hydrogen mixed gas (hydrogen concentration: 0.30 mol %) was fed continuously so that the overall pressure and the hydrogen concentration in the gas might be maintained constant during the polymerization. The hydrogen concentration within the system after the polymerization for 180 minutes was 1.33 mol % (the hydrogen concentration within the system was 1.38 mol % on average).

Then, butane, ethylene, and hydrogen were purged, so that 140.2 g of an ethylene-1-hexene copolymer was obtained. The physical properties of the resulting ethylene-1-hexene copolymer were shown in Table 1.

### Example 7

A 5-liter autoclave equipped with a stirrer dried under reduced pressure and then purged with argon gas was evacuated. Then, hydrogen was fed thereto so that its partial pressure might become 0.021 MPa, and subsequently 280 mL of 1-hexene and 1012 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.09 mol %. To the system was fed 1.0 mL of a heptane solution of triisobutylaluminum with a triisobutylaluminum concentration of 1.0 mmol/mL. Subsequently, 1.5 mL of a toluene solution of racemic ethylenebis(1-indenyl)zirconium diphenoxide with a racemic ethylenebis(1-indenyl) zirconium diphenoxide concentration of 1.0 μmol/mL was fed, and then 8.3 mg of the co-catalyst carrier (A1) obtained in the above-described Example 1(1) was fed. Polymerization was carried out at 70° C. for 180 minutes while ethylene/hydrogen mixed gas (hydrogen concentration: 0.24 mol %) was fed continuously so that the overall pressure and the hydrogen concentration in the gas might be maintained constant during the polymerization. The hydrogen concentration within the system after the polymerization for 180 minutes was 0.98 mol % (the hydrogen concentration within the system was 1.03 mol % on average). Then, butane, ethylene, and hydrogen were purged, so that 185.6 g of an ethylene-1-hexene copolymer was obtained. The physical properties of the resulting ethylene-1-hexene copolymer were shown in Table 1.

### Example 8

A 5-liter autoclave equipped with a stirrer dried under reduced pressure and then purged with argon gas was evacuated. Then, hydrogen was fed thereto so that its partial pressure might become 0.021 MPa, and subsequently 280 mL of 1-hexene and 1012 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.15 mol %. To the system was fed 2.0 mL of a heptane solution of triisobutylaluminum with a triisobutylaluminum concentration of 1.0 mmol/mL. Subsequently, 1.5 mL of a toluene solution of racemic ethylenebis(1-indenyl) zirconium diphenoxide with a racemic ethylenebis (1-indenyl) zirconium diphenoxide concentration of 1.0 μmol/mL was fed, and then 6.5 mg of the co-catalyst carrier (A1) obtained in the above-described Example 1(1) was fed. Polymerization was carried out at 70° C. for 180 minutes while ethylene/hydrogen mixed gas (hydrogen concentration: 0.24 mol %) was fed continuously so that the overall pressure and the hydrogen concentration in the gas might be maintained constant during the polymerization. The hydrogen concentration within the system after the polymerization for 180 minutes was 1.18 mol % (the hydrogen concentration within the system was 1.16 mol % on average). Then, butane, ethylene, and hydrogen were purged, so that 155.8 g of an ethylene-1-hexene copolymer was obtained. The physical properties of the resulting ethylene-1-hexene copolymer were shown in Table 1.

### Comparative Example 1

### (1) Treatment of Silica

500 ml of toluene as a solvent and 50.1 g of silica that had been heat treated at 300° C. under a nitrogen flow (Sylopol 948 produced by Davison Co., Ltd.; average particle diameter=55 μm; pore volume=1.67 ml/g; specific surface area=325 m²/g) were charged into a reactor equipped with a stirrer and purged with nitrogen, and then stirred. Then, after cooling the reactor to 5° C., a mixed solution of 28.5 ml of 1,1,1,3,3,3-hexamethyldisilazane and 38.3 ml of toluene was dropped over 30 minutes with the temperature within the reactor kept at 5° C. After completion of the dropping, stirring was continued at 5° C. for 1 hour and 95° C. for 3 hours, followed by filtration. The resulting solid component was washed with 500 ml of toluene six times and with 500 ml of hexane twice. Then, the solid component was dried at 23° C. under reduced pressure for 1 hour, so that 52.2 g of surface-treated silica gel was obtained.

### (2) Preparation of Co-Catalyst Carrier

To a 100-ml four-necked flask which had been dried under reduced pressure and then purged with nitrogen were charged 5.38 g of the surface-treated silica gel obtained in the above-described Comparative Example 1 (1) and 37.5 ml of toluene. Subsequently, 13.5 ml of a hexane solution of diethylzinc with a diethylzinc concentration of 2 mmol/ml was charged and stirred. Then, after cooling the flask to 5° C., 5.56 ml of a toluene solution of 3,4,5-trifluorophenol with a 3,4,5-trifluorophenol concentration of 2.42 mmol/ml was dropped over 60 minutes with the temperature within the flask kept at 5° C. After completion of the dropping, stirring was continued at 5° C. for one hour and at 40° C. for one hour. Then, 0.36 ml of water was dropped over 1.5 hours with the temperature within the flask kept at 5° C. After completion of the dropping, stirring was continued at 5° C. for 1.5 hours, at 40° C. for 2 hours, and further at 80° C. for 2 hours. After stopping stirring, the system was left at rest and 30 ml of supernatant liquid was extracted, 30 ml of toluene was charged, the temperature was increased to 95° C., stirring was carried out for 4 hours, followed by extraction of the supernatant liquid, so that a solid component was obtained. The resulting solid component was washed with 30 ml of toluene four times and with 30 ml of hexane three times. Subsequent drying afforded a solid constituent. Hereinafter, this solid component is called co-catalyst carrier (A2).

### (3) Polymerization

A 5-liter autoclave equipped with a stirrer dried under reduced pressure and then purged with argon gas was evacuated. Then, hydrogen was fed thereto so that its partial pressure might become 0.019 MPa, and subsequently 265 mL of 1-hexene and 1021 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 1.16 mol %. To the system was fed 2.0 mL of a heptane solution of triisobutylaluminum with a triisobutylaluminum concentration of 1 mmol/mL. Subsequently, 0.5 mL of a toluene solution of racemic ethylenebis(1-indenyl) zirconium diphenoxide with a racemic ethylenebis(1-indenyl)zirconium diphenoxide concentration of 1 μmol/mL was fed, and then 40.0 mg of the co-catalyst carrier (A2) prepared in the above-described Comparative Example 1(2) was fed. Polymerization was carried out at 70° C. for 180 minutes while ethylene/hydrogen mixed gas (hydrogen concentration: 0.18 mol %) was fed continuously so that the overall pressure and the hydrogen concentration in the gas might be maintained constant during the polymerization. The hydrogen concentration within the system after the polymerization for 180 minutes was 1.16 mol % (the hydrogen concentration within the system during the polymerization was 1.16 mol % on average). Then, butane, ethylene, and hydrogen were purged, so that 146.7 g of an ethylene-1-hexene copolymer was obtained. The physical properties of the resulting ethylene-1-hexene copolymer were shown in Table 2.

### Comparative Example 2

A 5-liter autoclave equipped with a stirrer dried under reduced pressure and then purged with argon gas was evacuated. Then, hydrogen was fed thereto so that its partial pressure might become 0.011 MPa, and subsequently 300 mL of 1-hexene and 999 g of butane were fed. After the temperature within the system was increased to 70° C., ethylene was fed thereto so that its partial pressure might become 1.6 MPa, and the system was stabilized. Gas chromatography analysis found that the gas composition in the system included a hydrogen concentration of 0.607 mol %. To the system was fed 2.0 mL of a heptane solution of triisobutylaluminum with a triisobutylaluminum concentration of 1 mmol/mL. Subsequently, 0.5 mL of a toluene solution of racemic ethylenebis (1-indenyl) zirconium diphenoxide with a racemic ethylenebis (1-indenyl) zirconium diphenoxide concentration of 1 μmol/mL was fed, and then 50.0 mg of the co-catalyst carrier synthesized by the same method as that used for the synthesis of component (A) disclosed in Example 33 of JP 2003-171412 A was fed. Polymerization was carried out at 70° C. for 180 minutes while ethylene/hydrogen mixed gas (hydrogen concentration: 0.103 mol %) was fed continuously so that the overall pressure and the hydrogen concentration in the gas might be maintained constant during the polymerization. The hydrogen concentration within the system after the polymerization for 180 minutes was 0.69 mol % (the hydrogen concentration within the system during the polymerization was 0.65 mol % on average). Then, butane, ethylene, and hydrogen were purged, so that 104.9 g of an ethylene-1-hexene copolymer was obtained. The physical properties of the resulting ethylene-1-hexene copolymer were shown in Table 2.

### Comparative Example 3

The physical properties of the ethylene•(1-butene)•(1-hexene) copolymer disclosed in Example 5 of JP 2004-149760 A are shown in Table 2.

### Comparative Example 4

The physical properties of the ethylene•(1-hexene) copolymer disclosed in Example 2 of JP 2006-307138 A are shown in Table 2. The physical properties provided in Table 2 are values measured for an ethylene•(1-hexene) copolymer without addition of antioxidants.

### Comparative Example 5

### (1) Treatment of Silica

22 kg of toluene as a solvent and 2.55 kg of silica (Sylopol 948 produced by Davison; average particle diameter: 55 μm; pore volume: 1.67 ml/g; specific surface area: 325 m²/g) as particle (d) that had been heated at 300° C. under a nitrogen gas flow were charged into a reactor equipped with a stirrer and purged with nitrogen, and then stirred. Then, after cooling the reactor to 5° C., a mixed solution of 0.823 kg of 1,1,1,3,3,3-hexamethyldisilazane and 1.29 kg of toluene was dropped over 30 minutes with the temperature of the reactor kept at 5° C. After completion of the dropping, stirring was continued at 5° C. for one hour and at 95° C. for three hours. Then, the resulting solid product was washed with 26 kg of toluene six times. Then, 4.7 kg of toluene was added and the system was left at rest overnight, so that a toluene slurry was obtained.

### (2) Preparation of Co-Catalyst Carrier (A3)

To the toluene slurry obtained in the above-described Comparative Example 5(1) was fed 4.92 kg of a 32 wt % hexane solution of diethylzinc, followed by stirring. Then, after cooling the flask to 5° C., a mixed solution of 0.944 kg of 3,4,5-trifluorophenol and 1.72 kg of toluene as a solvent was dropped over 60 minutes with the temperature of the flask kept at 5° C. After completion of the dropping, stirring was continued at 5° C. for one hour and at 40° C. for one hour. Then, 0.172 kg of water was dropped over 1.5 hours with the temperature within the flask kept at 5° C. After completion of the dropping, stirring was continued at 5° C. for 1.5 hours and at 40° C. for 2 hours and then the system was left at rest overnight. The reaction product slurry was stirred at 80° C. for 2 hours. Stirring was stopped and the supernatant liquid was removed until the remaining amount thereof became 14 liters. Then, 11.2 kg of toluene was fed and stirred. The temperature was increased to 95° C., followed by stirring for 4 hours. The resulting solid product was washed with 26 kg of toluene four times and with 20 kg of hexane three times. The subsequent drying afforded 4.10 kg of co-catalyst carrier (A3).

### (2) Preparation of Prepolymerized Catalyst

A preliminarily nitrogen-purged, 210-liter autoclave equipped with a stirrer was charged with 80 liters of butane and then 144 mmol of racemic-ethylenebis (1-indenyl) zirconium diphenoxide was charged, and the autoclave was heated up to 50° C., followed by stirring for two hours.

Then, 0.70 kg of the above-described co-catalyst carrier (A3) was charged and the autoclave cooled to 31° C., thereby stabilizing the inside of the system. Then, 0.1 kg of ethylene and 0.1 liters (volume at room temperature and normal pressure) of hydrogen was charged, and subsequently 263 mmol of triisobutylaluminum was charged, thereby starting polymerization. After 30 minutes had passed with ethylene and hydrogen continuously fed at 0.7 kg/Hr and 0.8 liters (volume at room temperature and normal pressure)/Hr, respectively, the temperature was raised to 50° C. and ethylene and hydrogen were fed continuously at 3.2 kg/Hr and 9.5 liters (volume at normal temperature and normal pressures)/Hr, respectively, and thus prepolymerization was carried out for 6 hours in total. After completion of the polymerization, ethylene, butane, hydrogen, and the like were purged, followed by vacuum drying of the residual solid at room temperature, whereby a prepolymerized catalyst component containing 23.8 g of polyethylene per gram of the co-catalyst carrier (A3) was obtained.

### (3) Production of Ethylene-α-Olefin Copolymer

Using the prepolymerized catalyst component obtained as described above, copolymerization of ethylene and 1-hexene was carried out in a continuous fluidized bed vapor phase polymerization apparatus, thereby obtaining an ethylene-1-hexene copolymer powder. The polymerization conditions included a polymerization temperature of 80.5° C., a polymerization pressure of 2 MPa, a molar ratio of hydrogen to ethylene of 0.20%, and a molar ratio of 1-hexene to ethylene of 1.67%. In order to keep gas composition constant, ethylene, 1-hexene and hydrogen were continuously supplied during the polymerization. Furthermore, the above-described prepolymerized catalyst component, triisobutylaluminum, and triethylamine (molar ratio thereof to triisobutylaluminum: 3%) were continuously supplied, so that the whole powder weight of 80 kg on the fluidized bed was kept constant. The average polymerization time was 3.8 hours. The resultant ethylene-1-hexene copolymer powder was pelletized by using an extruder (LCM50 manufactured by Kobe Steel, Ltd.) under the conditions including a feeding rate of 50 kg/hr, a screw rotation speed of 450 rpm, a degree of gate opening of 50%, a suction pressure of 0.1 MPa, and a resin temperature of 200 to 230° C., whereby an ethylene-1-hexene copolymer was obtained. The results of physical property evaluation using the resulting ethylene-1-hexene copolymer were shown in Table 2.

TABLE 1

| Physical | | | | | | | | |
|---|---|---|---|---|---|---|---|---|
| properties | Example 1 | Example 2 | Example 3 | Example 4 | Example 5 | Example 6 | Example 7 | Example 8 |
| MFR | 0.69 | 3.31 | 2.12 | 1.90 | 1.11 | 1.12 | 1.06 | 0.75 |
| (g/10 min) | | | | | | | | |
| Density | 921 | 921 | 920 | 920 | 921 | 921 | 919 | 919 |
| (Kg/m³) | | | | | | | | |
| Mw/Mn | 5.9 | 7.3 | 5.9 | 7.6 | 8.3 | 10.8 | 10.9 | 6.2 |
| (—) | | | | | | | | |
| η * _{0.1}/η * ₁₀₀ | 17.4 | 8.5 | 10.8 | 13.1 | 18.2 | 18.9 | 19.9 | 19.6 |
| (—) | | | | | | | | |
| Activation | 71.4 | 63.1 | 66.7 | 70.6 | 68.5 | 70.6 | 70.8 | 69.2 |
| energy | | | | | | | | |
| (kJ/mol/K) | | | | | | | | |
| MTV₁₅₀ | 62 | 80 | 72 | 63 | 51 | 65 | 74 | 57 |
| (m/min) | | | | | | | | |
| MTV₁₉₀ | 79 | 169 | 105 | 85 | 67 | 87 | 108 | 60 |
| (m/min) | | | | | | | | |
| MTV₁₅₀/MTV₁₉₀ | 0.78 | 0.48 | 0.68 | 0.74 | 0.76 | 0.74 | 0.68 | 0.96 |
| (—) | | | | | | | | |
| η * ₁₀₀ | 889 | 697 | 877 | 837 | 956 | 927 | 1052 | 1066 |
| (Pa · s) | | | | | | | | |
| Tensile | 1005 | 860 | 1065 | 1038 | 1026 | 1041 | 1170 | 1100 |
| impact | | | | | | | | |
| strength | | | | | | | | |
| (kJ/m²) | | | | | | | | |
| Mz/Mw | 2.4 | 2.2 | 2.3 | 2.3 | 2.2 | 2.4 | 2.5 | 2.4 |
| (—) | | | | | | | | |
| MFRR | 66 | 36 | 38 | 46 | 59 | 55 | 51 | 65 |
| (—) | | | | | | | | |
| ΔT_{1/2} | 1.7 | 1.4 | 1.5 | 1.5 | 1.7 | 1.1 | 1.5 | 1.8 |
| (° C.) | | | | | | | | |
| ΔH_{high}/ΔH | 0.12 | 0.11 | 0.14 | 0.12 | 0.11 | 0.10 | 0.11 | 0.12 |

TABLE 2

| | Compar- | Compar- | Compar- | Compar- | Compar- |
|---|---|---|---|---|---|
| | ative | ative | ative | ative | ative |
| Physical | Exam- | Exam- | Exam- | Exam- | Exam- |
| properties | ple 1 | ple 2 | ple 3 | ple 4 | ple 5 |
| MFR | 0.68 | 1.27 | 0.39 | 0.55 | 0.21 |
| (g/10 min) | | | | | |
| Density | 918 | 919 | 905 | 922 | 913 |
| (Kg/m³) | | | | | |
| Mw/Mn | 5.2 | 2.4 | 5.9 | 11.1 | 4.8 |
| (—) | | | | | |
| η*_{0.1}/η*₁₀₀ | 27.6 | 12.3 | 33.5 | 40.1 | — |
| (—) | | | | | |
| Activation | 73.9 | 64.5 | 73.1 | 71.6 | 73.3 |
| energy | | | | | |
| (kJ/mol/K) | | | | | |
| MTV₁₅₀ | 62 | 60 | 16 | 46 | 16.9 |
| (m/min) | | | | | |
| MTV₁₉₀ | 52 | 44 | 6 | 26 | 12.4 |
| (m/min) | | | | | |
| MTV₁₅₀/ | 1.19 | 1.35 | 2.56 | 1.75 | 1.36 |
| MTV₁₉₀ | | | | | |
| (—) | | | | | |
| η*₁₀₀ | 1016 | 1285 | 1082 | 910 | — |
| (Pa · s) | | | | | |
| Tensile | 1103 | 1417 | 1450 | 990 | 1339 |
| impact | | | | | |
| strength | | | | | |
| (kJ/m²) | | | | | |
| Mz/Mw | 2.5 | 2.0 | 2.6 | 3.0 | 2.7 |
| (—) | | | | | |
| MFRR | 73 | 39 | 98 | 124 | 126 |
| (—) | | | | | |
| ΔT_{1/2} | 2.0 | 2.0 | — | 10.4 | 12.9 |
| (° C.) | | | | | |
| ΔH_{high}/ | 0.13 | 0.13 | — | 0.32 | 0.28 |
| ΔH | | | | | |

### INDUSTRIAL APPLICABILITY

By the present invention, an ethylene-based polymer can be provided which is superior in balance between mechanical strength and extrusion load in processing and also superior in drawability in a high temperature region.

1. An ethylene-α-olefin copolymer comprising monomer units derived from ethylene and monomer units derived from an α-olefin having from 3 to 20 carbon atoms, wherein the copolymer has a melt flow rate of 0.01 to 100 g/10 min, a density of 860 to 970 kg/m³, a molecular weight distribution of 5.5 to 12, and an activation energy of flow of 50 to 100 kJ/mol, and when the maximum take-up rate of the copolymer at 150° C. is represented by MTV₁₅₀ and the maximum take-up rate of the copolymer at 190° C. is represented by MTV₁₉₀, MTV₁₅₀ is 40 m/min or more, and the ratio of MTV₁₅₀ to MTV₁₉₀ is 1 or less.

2. A film formed of a material comprising the ethylene-α-olefin copolymer according to claim 1.
